(19) United States
(12) Patent Application Publication
(10) Pub. No.: US 2018/0284033 A1
(43) Pub. Date: Oct. 4, 2018

(54) SYSTEM AND METHOD FOR COLOR SCANNING A MOVING ARTICLE

(71) Applicant: Centre de recherche industrielle du Québec, Quebec (CA)

(72) Inventors: Yvon Legros, Quebec (CA); Richard Gagnon, Quebec (CA)

(73) Assignee: Centre de recherche industrielle du Québec, Quebec (CA)

(21) Appl. No.: 15/938,950

(22) Filed: Mar. 28, 2018

(30) Foreign Application Priority Data
Mar. 31, 2017 (CA) 2962809

(51) Int. Cl. G01N 21/898; G01B 11/00; G01N 21/88

(52) U.S. Cl. CPC G01N 21/898; G01B 11/002; G01N 2201/06113; G01N 2021/8896; G01N 21/8851

(57) ABSTRACT

An optical apparatus and a method for color scanning a surface of an article moving along a travel path axis make use of an imaging sensor unit including a digital color camera capable of generating highly focused color images, even when distance from surface to camera varies, by providing the camera with an objective defining an optical plane disposed in Scheimpflug configuration. A beam of collimated polychromatic light of an elongated cross-section is directed within a Scheimpflug scanning plane of focus and toward a scanning zone to form a reflected linear band of light onto the article surface of an intensity substantially uniform within the depth of sensing field. The reflected linear band of light is captured by the digital camera to generate a two-dimensional color image thereof, from which a single line color image data is extracted. The line data extraction is repeated as the article moves to generate successive line color image data, from which a two-dimensional color image of the article is built.

### TECHNICAL FIELD

The present invention relates to the field of optical inspection technologies, and more particularly to optical inspection apparatus and method for color scanning articles in movement.

### BACKGROUND

Optical inspection apparatus and methods for scanning articles such as wooden boards while being transported on a conveyer using color cameras are well known. For example, Bouchard et al. (U.S. Pat. No. 8,502,180 B2) disclose an optical inspection apparatus provided with a first color image sensor unit using one or more illumination sources in the form of fluorescent tubes for directing polychromatic light toward a scanning zone to illuminate a scanned top surface of a board, and a first linear digital color camera, defining a sensing field directed perpendicularly to the transporting direction, is configured to capture an image of the illuminated board surface to generate corresponding color image data. According to such conventional color imaging approach as illustrated in FIG. 1, the image is formed by successively capturing reflected light rays to generate an image line at regular time intervals while the board is moving in direction of the shown arrow, wherein each line so captured is associated to a specific location on the scanned surface. Referring again to Bouchard et al., in addition to the color image sensor unit, the optical inspection apparatus is provided with a profile sensor unit using a laser source for directing a linear-shape laser beam toward a scanning zone to form a reflected laser line onto the scanned board surface, and a digital monochrome camera defining a sensing field and capturing a two-dimensional image of the reflected laser line to generate corresponding two-dimensional image data from which profile information is obtained through triangulation. Bouchard et al. further teach to provide the optical inspection apparatus with a second color image sensor unit using one or more illumination sources to illuminate a scanned bottom surface of the board, and a second digital color camera defining a sensing field and capturing an image of the illuminated board bottom surface to generate corresponding color image data. It is also known to provide further color image sensor units disposed so as to illuminate and capturing images of left and right side surfaces of the board to generate corresponding color image data.

Considering that boards to be scanned are typically moved in the transporting direction with a relatively high speed (typically 1 m/s and more), in order to provide highly focused color and profile images, a fixed focus and limited field of depth are set within the scanning zone, assuming that the position of the scanned board surface with respect to the conveyer surface (or to the camera objective) does not substantially vary, the field of depth being limited by the magnifying factor of the camera objective (i.e. an increase of magnifying factor is associated with a decrease of field of depth). In other words, it is assumed that the dimension of the board along an axis transverse to the transporting direction is such that the scanned surface is always passing through the scanning zone, and therefore within the preset field of depth. Such condition would exclude significant dimensional variations amongst the boards that are sequentially transported through the optical scanning apparatus. For example, in order to obtain highly focused color and profile images of top and bottom surfaces for a batch of boards, the thickness of the scanned boards must be substantially the same, or at least within a predetermined narrow range of thickness, which is typically of about 10 mm. Similarly, in order to obtain highly focused color and profile images of right and left side surfaces for a batch of boards, the width of the scanned boards must be substantially the same, or at least within a predetermined narrow range of width, being still typically of about 10 mm. However, in many cases, such requirements may not be complied with, either within a same batch of boards, or when several batches of boards exhibiting significant thickness and/or width differences are to be fed in sequence to the optical scanning apparatus, which differences may exceed 200 mm in practice. Furthermore, as illustrated in FIG. 1 (see board surface in phantom lines), illumination intensity at the target surface produced by conventional polychromatic light sources such as fluorescent tubes or punctual sources (e.g. incandescent, halogen, LED) is affected by a variation of source-to-surface distance, thereby causing undesirable brightness variation in color image obtained.

A known mechanical approach to provide depth of field adjustment consists of mounting the cameras and the light sources on an adjustable sliding mechanism. Although enabling adjustment between the inspection of batches of boards exhibiting significant thickness and/or width differences, such time-consuming mechanical approach is not capable of providing adjustment for each board within a given batch under inspection. Furthermore, cameras and light sources being fragile pieces of optical equipment, moving thereof on the sliding mechanism involves a risk of damage.

An optical approach to provide a large field of depth for obtaining highly focused profile images as disclosed by Lessard (U.S. Pat. No. 8,723,945 B2) consists of using a Scheimpflug adapter to extend the optical depth of the profile sensor unit so as to improve its inspection capability to boards of various widths. The known Scheimpflug configuration is illustrated in FIG. 2, which consists of disposing the objective lens of the camera (lens plane P_{L}) to a predetermined angle with respect to the plane of focus (P_{F}), to orientate the laser 10 so that the linear laser beam is coplanar with P_{F}, and to orientate the camera imaging sensor array, i.e. the image plane (Pᵢ), so that the image forming thereon is in focus on its entire sensing surface. Thus, any surface point lying within or approaching the plane of focus P_{F} will be substantially in focus within the resulting image, while any surface point lying away the plane of focus P_{F} will be out of focus. It can be appreciated from FIG. 2 and the side view of FIG. 4, that the laser line 12 formed by the linear laser beam reflecting on the board side surface will always be within the plane of focus P_{F} whatever the board width. Moreover, while it can be appreciated (see board surface in phantom lines) that the laser beam is somewhat affected by a variation of source-to-surface distance, for profile measurement purposes, it is only the deviation as seen by the camera that is used to derive profile information through triangulation. Therefore, the variation of source-to-surface distance does not affect the quality of profile images, even if brightness variation occurs as shown in FIG. 3.

However, there is still a need to apply an optical approach providing a large field of depth for obtaining highly focused color images.

### SUMMARY

It is a main object of the present invention to provide an optical apparatus and method for color scanning an article moving along a travel path axis, to generate highly focused color images.

According to the above-mentioned main object, from a broad aspect of the present invention, there is provided an apparatus for scanning a surface of an article moving along a travel path axis, comprising:
an imaging sensor unit having a sensing field transversely directed toward said travel path axis and defining a scanning zone traversed by a scanning plane of focus, said imaging sensor unit including:
   i. a source of polychromatic light configured for generating a light beam of an elongated cross-section;
   ii. a collimator configured for receiving said light beam and directing a beam of collimated polychromatic light within the scanning plane of focus and toward said scanning zone to form a reflected linear band of light onto said article surface; and
   iii. a digital color camera defining an image plane to capture the reflected linear band of light and generate a two-dimensional color image thereof, said digital color camera being provided with an objective defining an optical plane disposed in a Scheimpflug configuration wherein the optical plane, the image plane and the scanning plane of focus intersect one another substantially at a same geometric point to provide a large depth of said sensing field within which an intensity of said reflected linear band of light is substantially uniform; and
      data processing means programmed for extracting line color image data from the two-dimensional color image of said reflected linear band of light, and for building from said line color data a two-dimensional color image of said article surface upon the scanning thereof.

According to the same main object, from another broad aspect, there is provided a method for scanning a surface of an article moving along a travel path axis using an imaging sensor unit having a sensing field and defining a scanning zone traversed by a scanning plane of focus, and including a digital color camera provided with an objective defining an optical plane disposed in a Scheimpflug configuration wherein the optical plane, the image plane and the scanning plane of focus intersect one another substantially at a same geometric point to provide a large depth of said sensing field, the method comprising the steps of: i) directing the sensing field transversely toward said travel path axis while directing a beam of collimated polychromatic light of an elongated cross-section within the scanning plane of focus and toward said scanning zone to form a reflected linear band of light onto said article surface of an intensity substantially uniform within said depth of sensing field; ii) causing said digital color camera to capture said reflected band of light to generate a two-dimensional color image thereof; iii) extracting line color image data from the two-dimensional color image of said reflected linear band of light; iv) repeating said causing step ii) and said extracting step iii) as the articles moves to generate successive line color image data; and v) building from said successive line color image data a two-dimensional color image of said article surface.

In one embodiment of the article surface scanning method, the line color image data is extracted from color image pixels located within an elongate center area of said captured two-dimensional color image of the reflected linear band of light.

In another embodiment of the article surface scanning method, the two-dimensional color image is formed of a plurality of rows of color image pixels extending along said travel path axis, said line extracting step iii) including:
a) analysing each one of said rows of color image pixels to detect edges on both sides of said reflected linear band of light in said two-dimensional color image;
b) locating from said detected edges a center of said reflected linear band of light at each said row of color image pixels; and
c) deriving said line image data from color image pixels associated with each said located center of said reflected linear band of light.

### BRIEF DESCRIPTION OF THE DRAWINGS

Preferred embodiments of the present invention will now be described in detail with reference to the accompanying drawings in which:

FIG. 1 is a schematic representation of a color imaging approach according to the prior art;

FIG. 2 is a schematic representation of known Scheimpflug optical configuration for profile scanning of a board surface (prior art);

FIG. 3 is an end view of the scanned board of FIG. 1 as illuminated by a laser beam (prior art);

FIG. 4 is a side view along lines 4-4 of FIG. 3, showing the reflected laser line (piror art);

FIG. 5 is a schematic representation of an embodiment of scanning apparatus according to the present invention, as used for scanning a board;

FIG. 6 is an enlarged, partial end view of the scanned board of FIG. 5 as illuminated by a beam of collimated polychromatic light;

FIG. 7 is a partial side view along lines 7-7 of FIG. 6, showing the reflected linear band of light onto the board side surface;

FIG. 8 is a graphical representation of a final two-dimensional color image of a scanned article surface; and

FIG. 9 is a flow chart representing an example of image building algorithm for extracting line color image data and generating a two-dimensional color image therefrom.

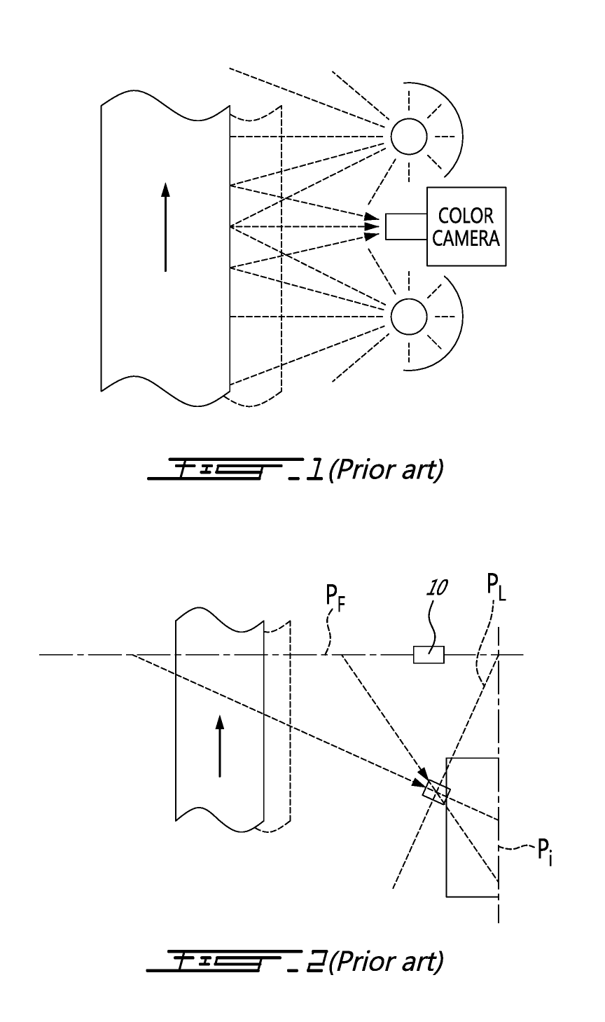

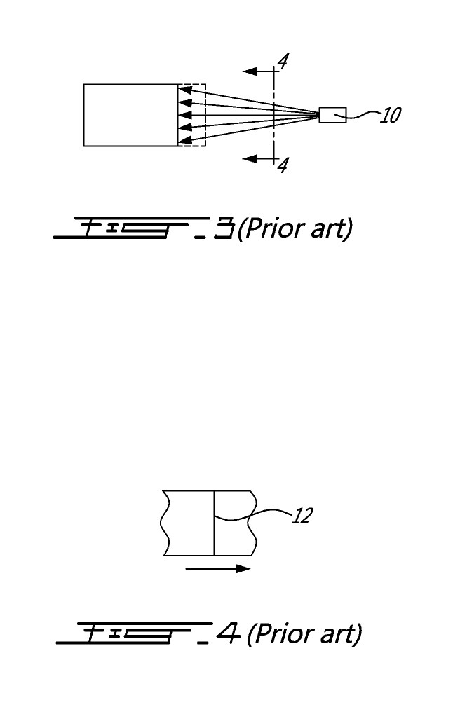

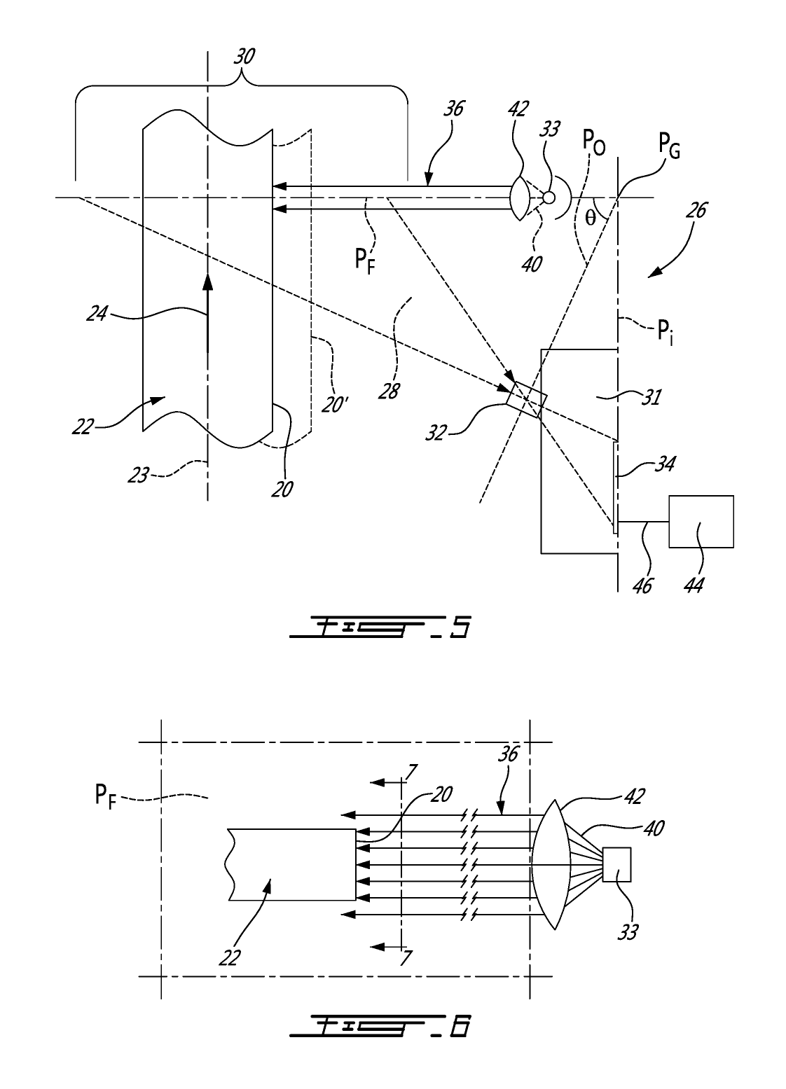

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

### DETAILED DESCRIPTION

While the invention has been illustrated and described in detail below in connection with example embodiments, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

The apparatus and method for scanning a surface of an article moving along a travel path axis according to example embodiments of the present invention, will now be described in the context of optical surface inspection of wooden boards, wherein the reflection-related characteristics of the scanned surface are associated with detected defects or surface properties such as knots, mineral streaks, slits, heartwood and sapwood areas. However, it is to be understood that the proposed color scanning apparatus and method according to the invention are not limited to wooden product inspection, and can be adapted to other inspection applications such as found in the automotive, aerospace, computer and consumer electronics industries.

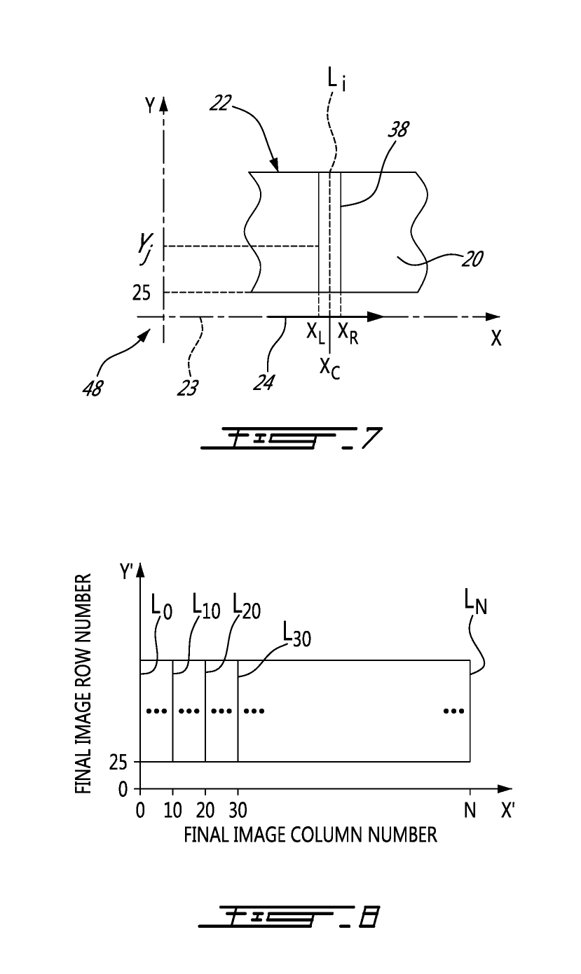

Referring now to FIG. 5, the embodiment of scanning apparatus is illustrated when used to scan a side surface 20 of a wooden board 22 moving along a travel path axis 23 in the direction shown by arrow 24, for example, upon operation of a conveyor (not shown) on which the board is disposed. Conveniently, feeding speed of the conveyor may be regulated to a predetermined value under the command of a controller receiving displacement indicative data from an appropriate displacement sensor such as a rotary encoder. The conveyer may be also provided with a presence sensor such as a photoelectric cell (not shown) to generate a signal indicating when the leading edge and trailing edge of a board 22 sequentially enter the scanning apparatus, as will be explained below in more detail. The apparatus includes an imaging sensor unit generally designated at 26 having a sensing field 28 transversely directed toward the travel path axis 23 and defining a scanning zone 30 traversed by a scanning plane of focus P_{F}, as shown perpendicular to travel path axis 23 and better shown in the end view of FIG. 6. Returning to FIG. 5, the imaging sensor unit 26 includes a digital color camera 31 defining an image plane Pᵢ and provided with an objective 32 defining an optical plane Pₒ and disposed in a Scheimpflug configuration wherein its optical plane Pₒ, the image plane Pᵢ and the scanning plane of focus PF intersect one another substantially at a same geometric point P_{G} to provide a large depth of sensing field. A digital color camera such as model SP-20000-CPX2 supplied by JAI Ltd. (Yokohama, Japan) may be used, with a Scheimpflug objective model PC-E NIKKOR 24 mm f/3.5D ED Tilt-Shift Lens supplied by Nikon Inc. (Melville, N.Y.). While such digital camera is configured to generate luminance and RGB (chrominance) two-dimensional color image signals, any other appropriate digital camera capable of generating color signal of another standard format, such as LAB and HSL, may be used. It can be appreciated from FIG. 5 that, according to the Scheimpflug configuration, the optical plane Pₒ forms a predetermined angle θ with respect to the scanning plane of focus P_{F}, and the imaging sensor array 34 of the camera 31, which is coplanar with image plane Pᵢ, is oriented so that the image forming thereon, as a representation of an illuminated portion of board surface within the scanning zone 30, is in focus on its entire sensing surface. Thus, any illuminated surface point lying within or approaching the plane of focus P_{F} will be substantially in focus within the resulting image, while any surface point lying away the plane of focus P_{F} will be substantially out of focus. However, attempting to apply a Scheimpflug configuration in hope of obtaining a large field of depth using linear camera for color scanning of moving articles is problematic with conventional illumination sources. Considering that an image line of interest is moving within the sensing field 28 of the imaging sensor unit 26, as a result of the movement of the scanned article surface, the position of the line of interest within the image is not known, making the Scheimpflug technique very difficult to implement with conventional illumination sources. Such implementation is even more problematic since illumination intensity is affected by the variation of source-to-surface distance, thereby causing undesirable brightness variation in color image obtained.

According to the present invention, a beam of collimated polychromatic light of an elongated cross-section within the scanning plane of focus P_{F} is directed toward the scanning zone to form a reflected band of light onto the board surface, of an intensity substantially uniform within the depth of sensing field. The reflected band of light is captured by the digital color camera to generate a two-dimensional color image thereof. Then, line color image data is extracted from the two-dimensional color image, to generate two-dimensional color image data upon the scanning of the article surface. In the embodiment of scanning apparatus as shown in FIG. 5 in view of FIG. 6, a source of polychromatic light 33 in the form of a fluorescent tube, halogen lamp or LED is configured for generating a light beam 40 of an elongated cross-section. Such source may be supplied by Opto Engineering (Houston, Tex.). In a variant embodiment, the source of polychromatic light 33 may be formed by several punctual sources of polychromatic light such as incandescent, halogen or LED devices adjacently mounted in a compact array. The scanning apparatus further includes a collimator 42 configured for receiving the light beam 40 and directing a beam of collimated polychromatic light 36 within the scanning plane of focus P_{F} and toward the scanning zone 30 to form the reflected band of light 38 onto the article surface 20, as better shown in FIG. 7. The collimator 42 may be any appropriate collimator such as cylinder Fresnel lens model 46-113 supplied by Edmund Optics (Barrington, N.J.). It can be appreciated from FIG. 5 in view of FIG. 7, that the light band formed by the beam reflecting on the board side surface will always be within the plane of focus P_{F} whatever the board width. The beam of collimated light exhibiting a sharp decrease in intensity on both sides along a direction parallel to the travel path axis indicated buy arrow 24, such intensity profile minimizes illumination interference between successive image scanning as the article is moving along the travel path axis and through the scanning zone. Furthermore, it can be appreciated (see article surface 20′ shown in phantom lines) that the collimated light beam is not substantially affected by a variation of source-to-surface distance, thus preventing undesirable intensity variation in color image obtained. The imaging sensor unit 26 further includes a data processing module 44 programmed with an appropriate image processing algorithm for extracting line color image data from the two-dimensional color image, to generate two-dimensional color image data upon the scanning of the article surface. The data processing module may be a computer provided with suitable memory and proper data acquisition interface configured to receive color image signals from digital camera 31 through data link 46. Although such computer may conveniently be a general-purpose computer, an embedded processing unit such as based on a digital signal processor (DSP), can also be used to perform image processing. It should be noted that the present invention is not limited to the use of any particular computer, processor or digital camera as imaging sensor for performing the processing tasks of the invention. The term “computer”, as that term is used herein, is intended to denote any machine capable of performing the calculations, or computations, necessary to perform the tasks of the invention, and is further intended to denote any machine that is capable of accepting a structured input and of processing the input in accordance with prescribed rules to produce an output. It should also be noted that the phrase “configured to” as used herein regarding electronic devices such as computer or digital camera, means that such devices are equipped with a combination of hardware and software for performing the tasks of the invention, as will be understood by those skilled in the art.

Conveniently, as shown in FIG. 7, the extracted line is chosen to be located at a center of the captured two-dimensional image of the reflected light band. For so doing, line color image data is extracted from color image pixels located within an elongate center area of the captured two-dimensional color image of the reflected light band. The accuracy of locating and extracting the line of interest Lᵢ within the center area mainly depends on the light generating stability inherent to the polychromatic light source used. It can be seen from a two-dimensional reference system 48 depicted in FIG. 7, that X axis is conveniently aligned to the travel path axis 23, so as to define x coordinate values associated with captured image column numbers, whereas Y axis defines y coordinate values associated with captured image line numbers, which x and y coordinates values are used for locating and extracting each line of interest Lᵢ to build the final two-dimensional color image.

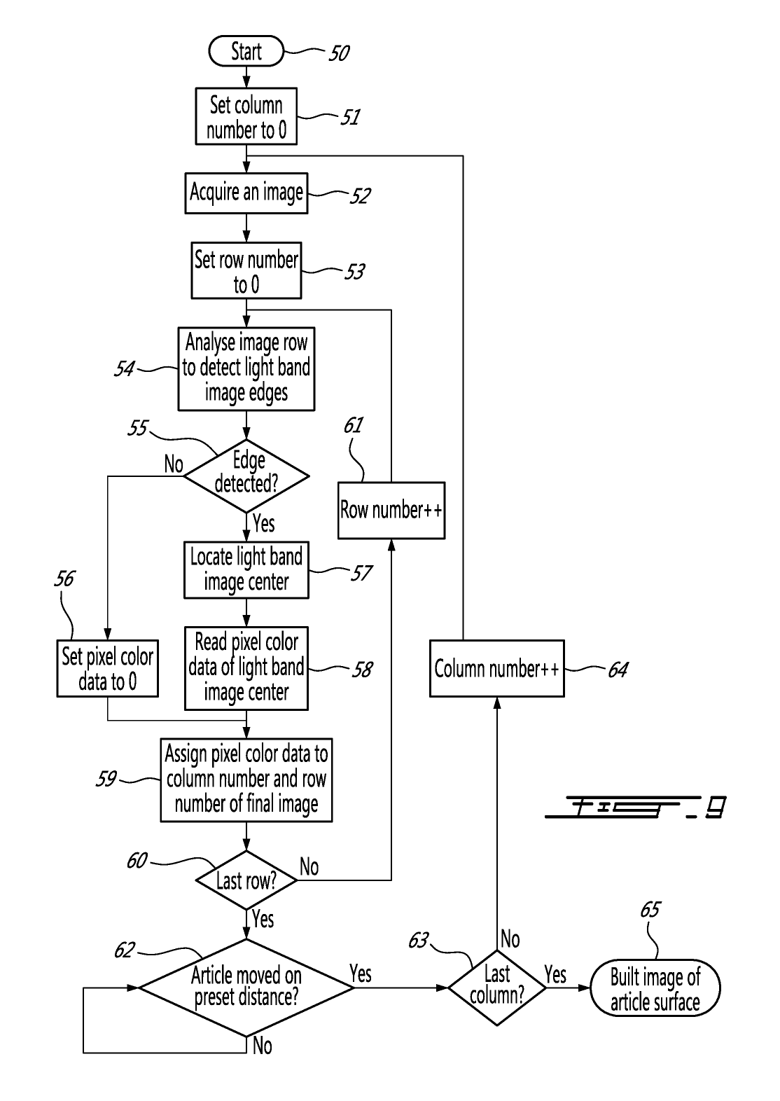

An example of image building algorithm for extracting line color image data and generating therefrom a two-dimensional color image of a scanned article surface will be now described in detail with reference to the flow chart of FIG. 9 in view of FIGS. 7 and 8, the latter being a graphical representation of the final two-dimensional color image with respect to a two-dimensional reference system 48′ having X′and Y′axis. Conveniently, the algorithm's start may be triggered at step 50 by the data processing module following reception of the signal indicating that the leading edge of an article has entered the scanning apparatus under known conveying speed to provide accurate triggering. Then, prior to enter an algorithm's main loop, a column number is set to 0 at a first initialization step 51, to designate a first column of the final color image to be built as schematically represented in the graph of FIG. 8, which first final image column is the destination of a first line L₀ to be extracted from the light band image 38 captured by the camera, as acquired by the data processing module at step 52 at entrance of the main algorithm's loop. It can be appreciated from FIG. 7, that for each pixel coordinate y, a captured image row of the light band image extends transversely between left edge coordinate x_{L} and right edge coordinate x_{R} located on both sides of a center at coordinate x_{C}. Then, prior to enter a following algorithm's sub-loop, a row number is set to 0 at a second initialization step 53, to designate a first row within the two-dimensional reference system 48′ used as a basis to build the final color image shown in FIG. 8. Then, at an entrance of the algorithm's sub-loop, the first image row is analysed at step 54 to detect edges of light band image. For so doing, the captured image may be binarized using a preset threshold followed by edge detection. While the location of the outer edges within the light band image is unknown at the beginning of image analysis, considering that the field of view of the camera as circumscribed by its imaging sensor array extends beyond the outer edges of the light band as reflected onto the scanned surface, one cannot expect to detect edges of light band image for the first and nearly adjacent image rows. Hence, at a decision step 55, until an edge is detected (i.e. whenever an edge is not detected) the pixel color data (e.g. luminance and chrominance components) corresponding to the currently processed row are set to 0 at step 56. Then, these null values are assigned at step 59 to the current column number and row number of the final image in the process of being built. Then, at a decision step 60, as long a predetermined last row, whose number depends on the size specification of the imaging sensor array, has not been processed, the current row number is incremented at step 61, and the processing within the sub-loop is repeated for the new current row from step 54 where the new current image row is analysed to detect edges of light band image. Whenever an edge has been detected, which occurs a first time when the lowermost edge of the scanned surface is detected at row number=25 in the example of FIGS. 7 and 8, affirmative decision at step 55 leads to following step 57, whereby the light band image center at current image row is located by estimating a coordinate x_{C} from associated left edge coordinate x_{L} and right edge coordinate x_{R} that have been previously obtained through edge detection step 54 and as shown in FIG. 7. For example, the center coordinate x_{C} may be obtained by calculating a midpoint location between left edge coordinate x_{L} and right edge coordinate x_{R}. Knowing the center coordinate x_{C}, the line image data can be derived from color image pixels associated with each located center. For so doing, at a following step 58, the pixel color data (luminance and chrominance components) associated with center coordinate x_{C} of the light band image is read from the data processing module memory. In practice, as the calculated center coordinate x_{C} is generally not an integer value precisely corresponding to a captured image column number, the pixel color data of the nearer column number may be chosen to be read. Alternatively, weighed pixel data can be calculated though interpolation using read pixel color data of proximate columns of the captured image. As described above, the algorithm's sub-loop from step 54 to step 59 is repeated upon row number incrementing at step 61 as long as the last row has not been processed. As soon as processing of the last row is completed, an affirmative decision at step 60 leads to a following decision step 62, whereby the data processing module determines, from received displacement indicative data, if the article under scanning has moved a preset distance (1 mm for example), corresponding to a desired image resolution along axis X′ as shown in FIG. 8. As long as the preset distance is not reached, the decision step 62 is looped back while the article is being conveyed further. As soon as the preset distance is reached, an affirmative decision at step 62 leads to a following decision step 63, whereby the data processing module determines if a last column has been processed, following reception of the signal indicating that the trailing edge of an article has entered the scanning apparatus under known conveying speed. As long as the last column has not been processed, negative decision at step 63 leads to column incrementing step 64, and the algorithm's main loop from image acquisition step 52 to decision step 63 is repeated until the last column has been processed, which is column N in the example of FIG. 8, ending with a final two-dimensional color image of the scanned article surface at 65, which is built from successive line color image data Lᵢ, represented by N+1 columns (L₀ . . . L₁₀ . . . L₂₀. . . L₃₀ . . . L_{N}) in the example of FIG. 8.

While the invention has been illustrated and described in detail above in connection with example embodiments, it is not intended to be limited to the details shown since various modifications and structural or operational changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

1. An apparatus for scanning a surface of an article moving along a travel path axis, comprising:
an imaging sensor unit having a sensing field transversely directed toward said travel path axis and defining a scanning zone traversed by a scanning plane of focus, said imaging sensor unit including:
a source of polychromatic light configured for generating a light beam of an elongated cross-section;
a collimator configured for receiving said light beam and directing a beam of collimated polychromatic light within the scanning plane of focus and toward said scanning zone to form a reflected linear band of light onto said article surface; and
a digital color camera defining an image plane to capture the reflected linear band of light and generate a two-dimensional color image thereof, said digital color camera being provided with an objective defining an optical plane disposed in Scheimpflug configuration wherein the optical plane, the image plane and the scanning plane of focus intersect one another substantially at a same geometric point to provide a large depth of said sensing field within which an intensity of said reflected linear band of light is substantially uniform; and
data processing means programmed for extracting line color image data from the two-dimensional color image of said reflected linear band of light, and for building from said line color image data a two-dimensional color image of said article surface upon scanning thereof.

2. A method for scanning a surface of an article moving along a travel path axis using an imaging sensor unit having a sensing field and defining a scanning zone traversed by a scanning plane of focus, and including a digital color camera provided with an objective defining an optical plane disposed in Scheimpflug configuration wherein the optical plane, the image plane and the scanning plane of focus intersect one another substantially at a same geometric point to provide a large depth of said sensing field, the method comprising the steps of:
i) directing the sensing field transversely toward said travel path axis while directing a beam of collimated polychromatic light of an elongated cross-section within the scanning plane of focus and toward said scanning zone to form a reflected linear band of light onto said article surface of an intensity substantially uniform within said depth of sensing field;
ii) causing said digital color camera to capture said reflected linear band of light to generate a two-dimensional color image thereof;
iii) extracting line color image data from the two-dimensional color image of said reflected linear band of light;
iv) repeating said causing step ii) and said extracting step iii) as the article moves to generate successive line color image data; and
v) building from said successive line color image data a two-dimensional color image of said article surface.

3. The article surface scanning method according to claim 2, wherein said line color image data is extracted from color image pixels located within an elongate center area of said captured two-dimensional color image of the reflected linear band of light.

4. The article surface scanning method according to claim 2, wherein said two-dimensional color image is formed of a plurality of rows of color image pixels extending along said travel path axis, said line extracting step iii) including:
a) analysing each one of said rows of color image pixels to detect edges on both sides of said reflected linear band of light in said two-dimensional color image;
b) locating from said detected edges a center of said reflected linear band of light at each said row of color image pixels; and
c) deriving said line image data from color image pixels associated with each said located center of said reflected linear band of light.
